(19) United States
(12) Patent Application Publication
(10) Pub. No.: US 2013/0223500 A1
(43) Pub. Date: Aug. 29, 2013

(54) DUAL CARRIER RECOVERY LOOP

(71) Applicants: Dan Weinholt, Vastra Frolunda (SE); Maurizio Moretto, Mediglia (Milano) (IT)

(72) Inventors: Dan Weinholt, Vastra Frolunda (SE); Maurizio Moretto, Mediglia (Milano) (IT)

(73) Assignee: Telefonaktiebolaget L M Ericsson (publ), Stockholm (SE)

(21) Appl. No.: 13/884,093

(22) PCT Filed: Nov. 9, 2010
(86) PCT No.: PCT/EP2010/067110

§ 371 Date: May 8, 2013

(51) Int. Cl. H04L 1/00

(52) U.S. Cl. CPC H04L 1/0036
USPC 375/226

(57) ABSTRACT

The present invention relates to a receiver being arranged to estimate a received signal. The receiver comprises demodulator means arranged to demodulate received signal data symbols of a higher constellation order such that a demodulated signal is obtained. The demodulator means comprises a main carrier recovery Phase-Locked Loop 9 arranged to demodulate 17 the data and pilot symbols. The demodulator means further comprises phase calculation means 5 arranged to provide 16 phase information from the pilot symbols of lower constellation order to the main carrier recovery PLL 9. The invention is particularly characterized in that the phase calculation means further comprises a pilot PLL 18 arranged to extract 15 the phase information from the pilot symbols. The invention also relates to a method in the receiver for estimating the received signal.

### TECHNICAL FIELD

The present invention relates to a receiver in a communication system for receiving digital communication, the receiver being arranged to estimate a transmitted signal, where the receiver comprises demodulator means arranged to demodulate received signal data symbols of a higher constellation order such that a demodulated signal is obtained. The present invention also relates to a method in the receiver for obtaining an estimation of the transmitted signal.

### BACKGROUND

QAM (Quadrature Amplitude Modulation) is a digital modulation/demodulation scheme. Two digital bit streams are conveyed by modulating the amplitude of the two carrier waves. To do this, an amplitude-shift keying suppressed carrier (ASK-SC) digital modulation scheme is used. The waves are out of phase with each other by 90 degrees and are called quadrature carriers/components. The modulated waves are summed and the result waveform is a combination of both phase-shift keying (PSK) and ASK.

When demodulating the waveform, phase tracking is a known method used in QAM. A carrier recovery loop is often used for enabling a coherent demodulation of high order QAM constellations. In order to improve the phase tracking performance, “pilot” symbols of lower constellation order are periodically inserted, such as for instance 4 QAM symbols. Pilot symbols of higher constellation order may be used for higher order QAM constellation demodulation.

The basic reason for performance improvements is the reduction in decision errors of these low constellation order “pilot” symbols as compared to the data symbols. The reduced error probability is utilized in the carrier recovery PLL (Phase Lock Loop) by applying a higher weight for pilot symbols relative the data symbols.

Even with different weights, this type of carrier recovery will produce fairly long error bursts and further improvement can be achieved by a “pre-estimation” of the carrier phase based on the pilot symbols provided that this symbol sequence is known by the receiver. The received signal is compensated by this pre-calculated phase before the carrier recovery PLL, which to a large extent reduce the burst error probability due to a reduced phase lag error in the PLL.

A problem with the solution is that the pilot symbols cannot be used for carrying data since a known sequence is used and the data throughput is thereby reduced in proportion to the rate of pilot symbols.

### SUMMARY

The object of the present invention is therefore to provide phase information from the pilot symbols, based on demodulated symbols instead of a known sequence, for the QAM carrier recovery PLL in order to avoid large errors in the PLL.

This object is obtained by means of a receiver in a communication system, the receiever being arranged to estimate a received signal. The receiver comprises demodulator means arranged to demodulate received signal data symbols of a higher constellation order such that a demodulated signal is obtained. The demodulator means comprises a main carrier recovery Phase-Locked Loop, PLL, arranged to demodulate the data and pilot symbols. The demodulator means further comprises phase calculation means arranged to provide phase information from the pilot symbols of lower constellation order to the main carrier recovery PLL. The receiver is particularly characterized in that the phase calculation means further comprises a pilot Phase-Locked Loop, PLL, arranged to extract the phase information from the pilot symbols.

The object of the present invention is also achieved by means of a method in a receiver in a communication system for estimating a received signal. The receiver comprises demodulator means demodulating received signal data symbols of a higher constellation order such that a demodulated signal is obtained. The demodulator means comprises a main carrier recovery Phase-Locked Loop demodulating the data and pilot symbols. The demodulator means further comprises phase calculation means providing phase information from the pilot symbols of lower constellation order to the main carrier recovery PLL. The method particularly comprises the step of a pilot Phase-Locked Loop, PLL, in the phase calculation means extracting the phase information from the pilot symbols.

Several advantages are obtained by means of the present invention. For example since demodulated pilot symbols are used instead of a known sequence, the data throughput is increased. Since the phase calculation from the pilot symbols is based on demodulated symbols, these pilot symbols can be used to carry data. Further advantages will emerge from the detailed description.

### BRIEF DESCRIPTION OF THE DRAWINGS

The present invention will now be described more in detail with reference to the appended drawings, where:

FIG. 1 schematically shows a known pilot symbol aided receiver;

FIG. 2 schematically shows a pilot symbol aided receiver according to the present invention;

FIG. 3 shows a flow chart of a method according to the present invention.

### DETAILED DESCRIPTION

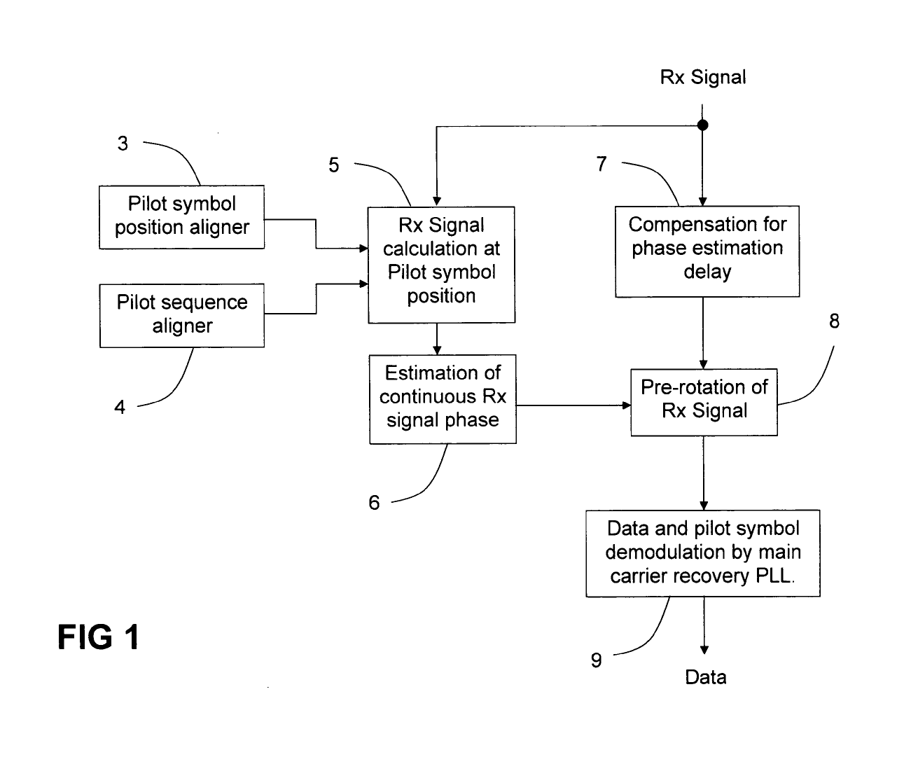

FIG. 1 shows a known pilot symbol aided receiver for coherent demodulation of high order QAM constellations. The receiver is arranged for estimating a received signal (Rx Signal). The receiver comprises demodulator means arranged to demodulate the received signal (Rx Signal) data symbols of a higher constellation order such that a demodulated signal (Data) is obtained.

In the following, a receiver embodiment will be described. Said receiver comprises means arranged to perform certain procedures or method step. It should therefore be understood by a person skilled in the art that the embodiment also illustrates a method in the receiver for estimating a received signal.

The demodulator means comprises a main carrier recovery Phase-Locked Loop, PLL, 9 arranged to demodulate the data and pilot symbols. The demodulator means further comprising phase calculation means 5 arranged to provide phase information from the pilot symbols of lower constellation order to the main carrier recovery PLL. The higher constellation of the data symbols may be for instance 256 QAM (Quadrature Amplitude Modulation), while the lower constellation of the pilot symbols is an even multiple of the higher constellation in terms of phase ambiguity, such as for instance 4 or 8 QAM. Higher constellations than 256 QAM for the data symbols is also possible within the scope of the present invention.

The receiver further comprises compensation means 7 to compensate the delay of the received signal and means 8 to pre-rotate the received signal. Furthermore, the receiver comprises means 6 to estimate the continuous phase of the received signal, wherein the pre-rotation is based on the estimated signal. The pre-rotated signal is fed to means 9 to decide upon the data and pilot symbols, said means comprising the main carrier recovery PLL (Phase Lock Loop) 9 enabling a coherent demodulation of the higher order constellations.

The phase calculation means 5 periodically provides pilot symbols of lower constellation order, for example 4 or 8 QAM, to said means 6 for estimating the continuous phase of the signal. Pilot symbols of higher constellation order may be used for data symbols with higher constellation order. The constellation order of the data symbols is always higher than the (lower) constellation order of the pilot symbols. In order to provide information for the pilot symbols phase calculation, means 3 to align the pilot symbol position and means 4 to align the pilot sequence are provided. Said means provide said information to the phase calculation means.

The object of the present invention is to provide phase information from the pilot symbols, based on demodulated symbols instead of a known sequence, for the QAM carrier recovery PLL in order to avoid large errors in the PLL.

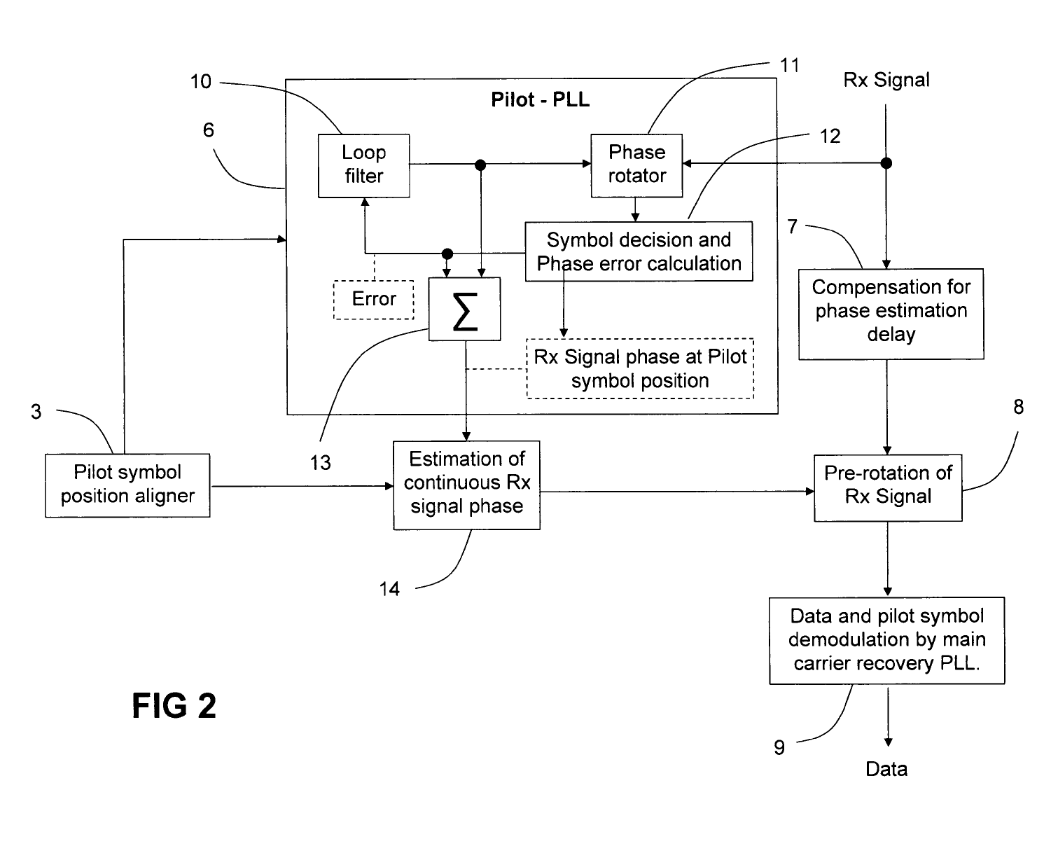

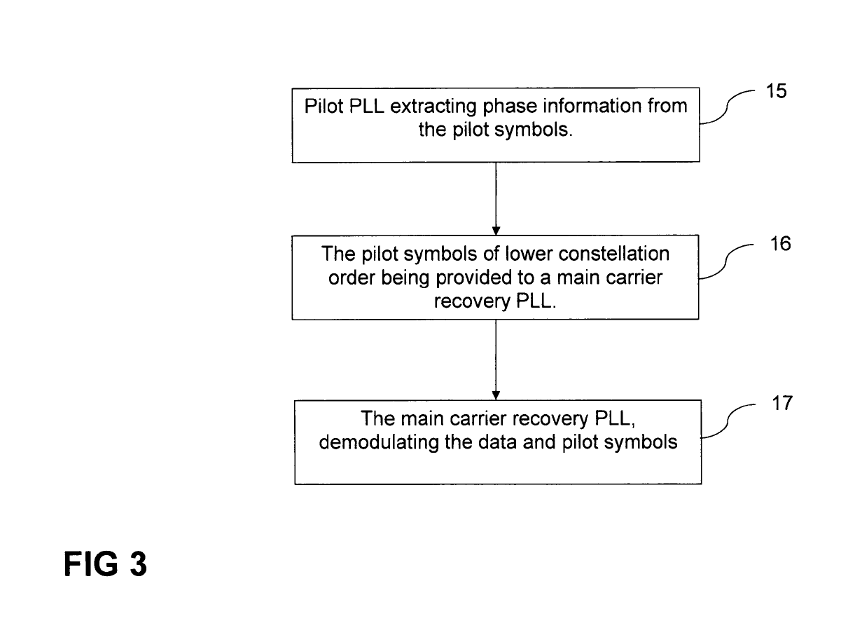

The object is solved by a phase calculation means 5, which comprises a pilot Phase-Locked Loop, PLL, 18 being arranged to extract 15 the phase information from the pilot symbols, see FIGS. 2 and 3.

The advantage with this solution is that since demodulated pilot symbols are used instead of a known sequence, the data throughput is increased. Since the phase calculation from the pilot symbols is based on demodulated symbols, these pilot symbols can be used to carry data. The pilot PLL 18 is preferably arranged to extract phase information with a 90 degrees or 180 degrees ambiguity. This is required in case of N-QAM modulation, which is the baseline.

FIG. 2 shows an example of a pilot-PLL 18. The pilot-PLL comprises means 11 to rotate the phase of the received signal (Rx Signal). The pilot-PLL further comprises means 12 to calculate the pilot symbol of the received signal. Said pilot-PLL also comprises means arranged to add a tracking error (Error) of the received signal to the pilot PLL. Said means 12 consist in a slicer being able to create the pilot symbol and the tracking error. Note that the pilot PLL uses the tracking error for all symbols, not only pilot symbols

The pilot-PLL further comprises means 10 to filter the tracking error of the received signal, said filtered error being fed back to said means 11 rotating the phase of the received signal.

In order to achieve the true phase of the pilot symbols, the pilot-PLL 18 further comprises means 13 arranged to combine the tracking error with filtered pilot symbols into the phase information of the received signal. Thereby phase information from the pilot symbols is extracted instead of using knowledge of the pilot sequence. This also means that the pilot-PLL 18 only receives means 3 to align the pilot symbol position. No information about the pilot sequence is provided.

The demodulator further comprises means 14 to estimate the phase of the continuous received signal on the basis of the extracted phase information from the pilot symbols. The demodulator further comprises means 8 to use the estimated phase of the received signal phase in a pre-rotation of the received signal.

The main carrier recovery PLL 9 is arranged to use the pre-rotated, received signal to demodulate the data and pilot symbols. Since the received signal is pre-rotated on the basis of the estimated continuous phase of the received signal, and since the phase is estimated on the basis of a phase calculation based on demodulated pilot symbols instead of a known sequence, data throughput is higher than when a known sequence is used for the phase estimation.

The present invention is not limited to the examples above, but may vary freely within the scope of the claims. For example, the receiver does not have to be a receiver for QAM demodulation. Instead, the present invention can be used in any receiver where there is a need to provide coherent demodulation and where the phase tracking using pilot symbols have to be improved. The requirement is however that the demodulation is performed by using a Phase Lock Loop.

Furthermore, the receiver may be made in many different ways known to the skilled person, the shown arrangement is only one example of many. Furthermore, some components may be omitted and some, thus not shown components, may be added.

The present invention relates to the receiver, although the receiver is intended to be used together with a transmitter. It should nevertheless be understood that the present invention only lies in the receiver.

The present invention is finally applicable for any type of modulation that may be represented by means of a I component and a Q component, for example PSK, Phase Shift Keying.

1. Receiver in a communication system, the receiver being arranged to estimate a received signal (Rx Signal), where the receiver comprises demodulator means arranged to demodulate received signal data symbols of a higher constellation order such that a demodulated signal (Data) is obtained, the demodulator means comprising a main carrier recovery Phase-Locked Loop, PLL, (9) arranged to demodulate (17) the data and pilot symbols, the demodulator means further comprising phase calculation means arranged to provide (16) phase information from the pilot symbols of lower constellation order to the main carrier recovery PLL (9),
characterized in that
the phase calculation means further comprises a pilot Phase-Locked Loop, PLL, (18) arranged to extract (15) the phase information from the pilot symbols.

2. Receiver according to claim 1 wherein the pilot PLL (18) comprise means (12) arranged to add a tracking error of the received signal (Rx Signal) to the pilot PLL (18).

3. Receiver according to claim 2 wherein the pilot PLL (18) comprise means (13) arranged to combine the tracking error with filtered pilot symbols into the phase information of the received signal (Rx Signal).

4. Receiver according to any of the preceding claims wherein the demodulator means is arranged to estimate the continuous received signal phase on the basis of the phase information.

5. Receiver according to claim 5 wherein the demodulator means is arranged to use the continuous received signal phase in a pre-rotation of the received signal (Rx Signal).

6. Receiver according to claim 5 wherein the main carrier recovery PLL (9) is arranged to use the pre-rotated received signal to demodulate the data and pilot symbols.

7. Receiver according to any of the preceding claims wherein the pilot PLL (18) is arranged to extract phase information with a 90 degrees ambiguity.

8. A method in a receiver in a communication system for estimating a received signal (Rx Signal), where the receiver comprises demodulator means demodulating received signal data symbols of a higher constellation order such that a demodulated signal is obtained (Data), the demodulator means comprising a main carrier recovery Phase-Locked Loop (9) demodulating (17) the data and pilot symbols, the demodulator means further comprising phase calculation means providing (16) phase information from the pilot symbols of lower constellation order to the main carrier recovery PLL (9), the method comprising the step of:
a pilot Phase-Locked Loop, PLL, (18) in the phase calculation means extracting (15) the phase information from the pilot symbols.

9. Method according to claim 8 wherein the pilot PLL (18) adds a tracking error of the received signal to the pilot PLL (18).

10. Method according to claim 9 wherein the pilot PLL (18) combines (13) the tracking error with filtered pilot symbols into the phase information of the received signal (Rx Signal).

11. Method according to any of the claims 8-10 wherein the demodulator means estimates the continuous received signal phase on the basis of the phase information.

12. Method according to claim 11 wherein the demodulator means uses the continuous received signal phase in a pre-rotation of the received signal (Rx Signal).

13. Method according to claim 12 wherein the main carrier recovery PLL (9) uses the pre-rotated received signal to demodulate the data and pilot symbols.

14. Method according to any of the claims 8-13 wherein the pilot PLL (18) extracts phase information with a 90 degrees ambiguity.
